(19) United States
(12) Patent Application Publication
(10) Pub. No.: US 2008/0102528 A1
(43) Pub. Date: May 1, 2008

(54) AUTOMATIC BIOCHEMICAL ANALYZING METHOD AND APPARATUS

(75) Inventors: Zhi Xu, Shenzhen (CN); Chuanfen Xie, Shenzhen (CN); Chao Zeng, Shenzhen (CN)

Correspondence Address: BEYER WEAVER LLP, P.O. BOX 70250, OAKLAND, CA, 94612-0250, US

(73) Assignee: SHENZHEN MINDRAY BIO-MEDICAL ELECTRONICS CO., LTD., Shenzhen (CN)

(21) Appl. No.: 11/923,376

(22) Filed: Oct. 24, 2007

(30) Foreign Application Priority Data
Oct. 27, 2006 (CN) 200610022173.9

(51) Int. Cl. G01N 35/02

(52) U.S. Cl. 436/47; 422/67

(57) ABSTRACT

An automatic biochemical analyzing method is described, in which a row of reaction containers is cyclically arrayed such that an operating cycle is formed that is defined between dispensing the preceding sample and the sequent sample. In each cycle, the reaction containers are transferred so as to motivate at least one reaction container to pass across an optical detecting channel and cause the reaction containers to make an intermediate pause when no sample is dispensed. When the reaction containers pause, the sample is dispensed to a reaction container at a sample dispensing position. When the reaction containers are at the intermediate pause, the first reagent is dispensed to a reaction container at a first reagent dispensing position. In each reaction container, the operation cycle when the sample is dispensed follows the operation cycle when the first reagent is dispensed. An automatic biochemical analyzing apparatus is also disclosed.

### BACKGROUND OF THE INVENTION

1. Field of the Invention

The present invention relates to a method and an apparatus for automatically analyzing multi-analysis biochemical items.

2. Discussion of the Related Art

At present, automatic biochemical analyzing apparatuses are a kind of biochemical analyzing products most widely applied. An automatic biochemical analyzing apparatus for use in clinical experiments is used to assay biochemical indexes of blood, urine, or other body fluids, with characteristics of simulating manual operations to accomplish a series of processes during biochemical analyzing, including dispensing reagents and samples, mixing, heat-preserving reaction, detecting absorbency, and calculating data results, etc. The biochemical analyzing apparatus mainly consists of a reaction disk having a constant temperature system, a sample disk or a sample delivery rack, a reagent disk, a sample dispensing mechanism, a reagent dispensing mechanism, a stirring mechanism, a cleaning mechanism for reaction cups, and a user operating system.

A biochemical analyzing apparatus capable of simultaneously analyzing multi-biochemical items is disclosed in both U.S. Pat. No. 5,776,662 and United States Patent Publication No. 2005/0123446 A1, wherein the biochemical analyzing apparatus of U.S. Pat. No. 5,776,662 applies a reagent probe to cooperate with a reagent disk to accomplish operations of dispensing a first reagent, a second reagent, and a third reagent. Yet, as the reagent probe accomplishes operations of dispensing the three reagents in a working period, the speed of testing the entire system is slowed down and cross-contamination among reagents is readily induced.

### SUMMARY OF THE INVENTION

An objective of the present invention is to provide an automatic biochemical analyzing method that can reduce cross-contamination among reagents and improve operating speed thereof.

Another objective of the present invention is to provide an automatic biochemical analyzing apparatus that can reduce cross-contamination among reagents and improve operating speed thereof.

In accordance with a preferred embodiment of the present invention, an automatic biochemical analyzing method is provided for realizing the above first objective. The automatic biochemical analyzing method in which a row of reaction containers is cyclically arrayed in a loop such that a unit operating cycle is formed that is defined between dispensing (e.g., adding) the preceding sample and the sequent sample to the reaction containers. The row of reaction containers are transferred so as to motivate at least one reaction container to pass across an optical detecting channel during the unit operating cycle and cause the row of reaction containers to make at least one intermediate pause when no sample is dispensed. A first reagent dispensing position and a sample dispensing position are orderly and separately arranged at the transferring route of the row of reaction containers. When the row of reaction containers pauses to dispense the sample, the sample is dispensed to a reaction container at the sample dispensing position. When the row of reaction containers are at the intermediate pause, the first reagent is dispensed to a reaction container at the first reagent dispensing position. In each reaction container, the operation cycle when the sample is dispensed follows the operation cycle when the first reagent is dispensed.

Preferably, the transferring route of the row of reaction containers further has a second reagent dispensing position. The first reagent dispensing position, the sample dispensing position and the second reagent dispensing position are orderly and separately arranged. When the row of reaction containers pauses to dispense the sample, the second reagent is dispensed to a reaction container at the second reagent dispensing position. In each reaction container, the operation cycle when the second reagent is dispensed follows the operation cycle when the sample is dispensed.

Preferably, the transferring route of the row of reaction containers further has a sample stirring position and a reagent stirring position. The first reagent dispensing position, the sample stirring position, the reagent stirring position, the sample dispensing position and the second reagent dispensing position are orderly and separately arranged. When the row of reaction containers pauses to dispense the sample, the first reagent is dispensed to a reaction container at the reagent dispensing position. At the intermediate pause, the sample in a reaction container at the sample stirring position is stirred.

Preferably, the dispensing operations of the first reagent, the second reagent and the sample are respectively performed by a first reagent probe assembly, a second reagent probe assembly, and a sample probe assembly. When the row of reaction containers pauses to dispense the sample, the first reagent probe assembly extracts the first reagent in a corresponding reagent container, the second reagent probe assembly dispenses the second reagent to a corresponding reaction container, and the sample probe assembly dispenses the sample to a respective reaction container. At the intermediate pause, the first reagent probe assembly dispenses the first reagent in a new corresponding reaction container, the second reagent probe assembly extracts the second reagent in a new corresponding reagent container, and the sample probe assembly extracts the sample from a new respective reaction container.

Preferably, the transferring route of the row of reaction containers further has a cleaning position. The first reagent dispensing position, the cleaning position, the sample dispensing position and the second reagent dispensing position are orderly and separately arranged, and when at the intermediate pause, the reaction container at the cleaning position is cleaned.

In accordance with another preferred embodiment of the present invention, an automatic biochemical analyzing apparatus is provided for realizing the above second objective. The automatic biochemical analyzing apparatus comprises a driving mechanism configured to drive a row of reaction containers to transfer so as to motivate at least one reaction container to pass across an optical detecting channel during a unit operating cycle that is defined between dispensing the preceding sample and the sequent sample to the row of reaction containers arrayed on a reaction disk, and a controlling system configured to cause the row of reaction containers to make at least one intermediate pause when no sample is dispensed during the unit operating cycle. The apparatus further comprises a first reagent probe assembly and a sample probe assembly respectively performing dispensing operations at a first reagent dispensing position and a sample dispensing position. The two dispensing positions are separately arranged at the transferring route of the row of reaction containers. The controlling system controls the first reagent probe assembly and the sample probe assembly to: dispense the sample to a reaction container at the sample dispensing position via the sample probe assembly when the row of reaction containers pauses to dispense the sample; and dispense the first reagent to a reaction container at the first reagent dispensing position when the row of reaction containers are at the intermediate pause. In each reaction container, the operation cycle when the sample is dispensed follows the operation cycle when the first reagent is dispensed.

Preferably, the automatic biochemical analyzing apparatus further comprises a second reagent probe assembly configured to perform dispensing operation at a second reagent dispensing position which is at the transferring route of the row of reaction containers and is interposed between the first reagent dispensing position and the sample dispensing position. When the row of reaction containers pauses to dispense the sample, the controlling system controls the second reagent probe assembly to dispense the second reagent to a reaction container at the second reagent dispensing position. In each reaction container, the operation cycle when the second reagent is dispensed follows the operation cycle when the sample is dispensed.

Preferably, the automatic biochemical analyzing apparatus comprises a sample stirrer assembly and a reagent stirrer assembly configured to respectively perform stirring operations at a sample stirring position and a reagent stirring position at the transferring route of the row of reaction containers. When the row of reaction containers pauses to dispense the sample, the controlling system controls the sample stirrer assembly to stir the sample in a reaction container at the sample stirring position and controls the reagent stirrer assembly to stir the second reagent in a reaction container at the reagent stirring position.

Preferably, the automatic biochemical analyzing apparatus further comprises a reagent disk configured to support the first and second reagents and a sample disk configured to support the sample. The reagent disk and the sample disk are disposed at two sides of the reaction disk. The first and second reagent probe assemblies are interposed between the reagent disk and the reaction disk. The first reagent probe assembly is arranged at a rear position and the second reagent probe assembly is arranged at a front position. The sample probe assembly is interposed between the reaction disk and the sample disk. The reagent stirrer assembly and the sample stirrer assembly are arranged around the reaction disk. The reagent stirrer assembly is adjacent to the sample probe assembly and the sample stirrer assembly is adjacent to the first reagent probe assembly.

Preferably, the automatic biochemical analyzing apparatus further comprises a first reagent disk configured to support the first reagent, a second reagent disk configured to support the second reagent, and a sample disk configured to support the sample. The first reagent disk and the second reagent disk are disposed on one side of the reaction disk, and the sample disk is disposed on the other side of the reaction disk. The first reagent probe assembly is interposed between the first reagent disk and the reaction disk. The second reagent probe assembly is interposed between the second reagent disk and the reaction disk. The first reagent probe assembly is arranged at a rear position and the second reagent probe assembly is arranged at a front position. The sample probe assembly is interposed between the reaction disk and the sample disk. The reagent stirrer assembly and the sample stirrer assembly are arranged around the reaction disk. The reagent stirrer assembly is adjacent to the sample probe assembly and the sample stirrer assembly is adjacent to the first reagent probe assembly.

Preferably, the automatic biochemical analyzing apparatus further comprises a cleaning mechanism configured to clean the reaction container at a cleaning position at the transferring route of the row of reaction containers, when at the intermediate pause, the reaction container at the cleaning position is cleaned by the cleaning mechanism.

In the present automatic biochemical analyzing apparatus and analyzing method, as each of the reagents is dispensed to the same reaction container at different positions via different reagent probe assembles, the cross contamination among the reagents can be reduced and the operating speed can be improved. Moreover, the first reagent is dispensed prior to dispensing the sample, thereby ensuring the desired reaction temperature.

Other and further objects of the invention will be apparent from the following drawings and the description of preferred embodiments of the invention.

### BRIEF DESCRIPTION OF THE DRAWINGS

Many aspects of the present automatic biochemical analyzing apparatus and the analyzing method can be better understood with reference to the following drawings. The components in the drawings are not necessarily drawn to scale, and the emphasis is placed upon clearly illustrating the principles of the present automatic biochemical analyzing apparatus and the analyzing method.

FIG. 1 is a schematic view of the automatic biochemical analyzing apparatus, in accordance with a preferred embodiment of the present invention.

FIG. 2 is a schematic view of a reaction disk of the automatic biochemical analyzing apparatus with various operating positions, in accordance with the preferred embodiment of the present invention.

FIG. 3 is a schematic view of a reagent disk of the automatic biochemical analyzing apparatus with various operating positions, in accordance with the preferred embodiment of the present invention.

FIG. 4 is a schematic view of a sample disk of the automatic biochemical analyzing apparatus with various operating positions, in accordance with the preferred embodiment of the present invention.

FIG. 5 is an operation schedule graph of the automatic biochemical analyzing method, in accordance with a preferred embodiment of the present invention.

FIG. 6 is a measuring flowchart of the automatic biochemical analyzing method, in accordance with the preferred embodiment of the present invention.

### DESCRIPTION OF THE PREFERRED EMBODIMENTS

Reference will now be made to the figures to describe the present invention in detail.

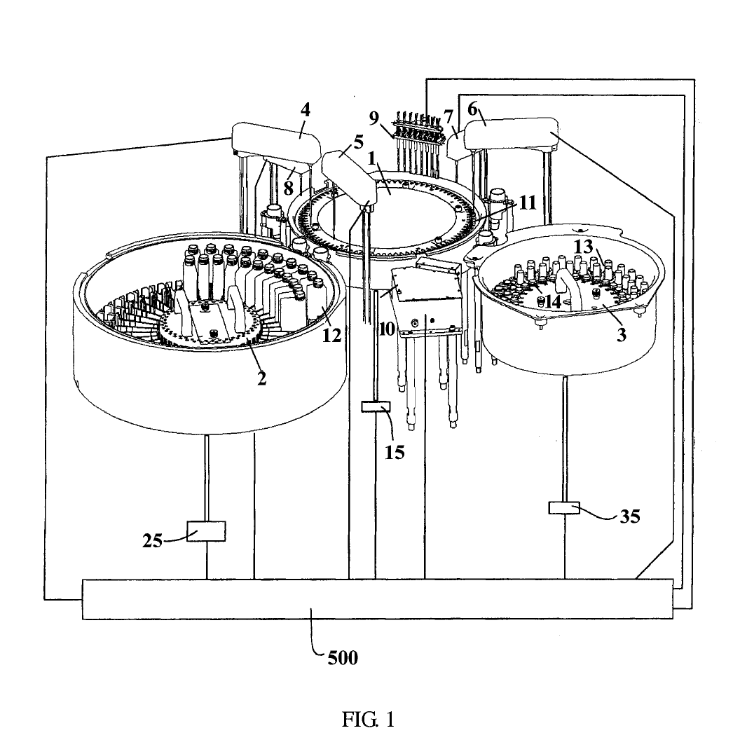

Referring to FIG. 1, an automatic biochemical analyzing apparatus, in accordance with a preferred embodiment of the present invention, includes a reaction disk 1, a reagent disk 2, a sample disk 3, a first reagent probe assembly 4, a second reagent probe assembly 5, a sample probe assembly 6, a reagent stirrer assembly 7, a sample stirrer assembly 8, a reaction container cleaning mechanism 9, an optical detector 10, and a controlling system 500 configured to control operations of the reaction disk 1, the reagent disk 2, the sample disk 3, the cleaning mechanism 9, the optical detector 10 and the assemblies described above.

The reaction disk 1 is, for example, arranged on a surface of a working platform in a rearward center position. Ninety reaction containers 11 (e.g., cups or vessels) are arranged in a uniform interval along the circumference of the reaction disk 1. The reaction cups 11 are configured to be permanent or half-permanent. A reaction disk driving mechanism 15 is operable to drive the reaction disk to rotate so as to achieve rotary orientation of the reaction cups. The reaction disk 1 has a constant temperature system, for preserving the temperature of reaction liquid in the reaction cups (e.g., at 37° C.).

The reagent disk 2 is, for example, arranged on the surface of the working platform in a anterior left-hand position, along the inner and outer circumferences of which two groups of forty reagent positions are respectively arranged in a uniform interval. The reagent positions are configured to support reagent bottles 12 each containing a first or a second reagent for use in biochemical examination. A reagent disk driving mechanism 25 is operable to drive the reagent disk to rotate the reagent bottles 12 so as to achieve the rotary orientation thereof. The reagent disk has a function of refrigeration for extending the service life of reagents and reducing volatilization of reagents.

The sample disk 3 is, for example, arranged on the surface of the working platform in a anterior right-hand position, along the inner, middle and outer circumferences of which three groups of thirty sample positions are respectively arranged in a uniform interval. The sample positions are configured to support sample container (e.g., test-tube, vessel or cuvette) 13 containing sample to be examined, calibrating liquid, or quality-control liquid, etc. A sample disk driving mechanism 35 is operable to drive the sample disk to rotate the reagent bottles 12 so as to accomplish the rotary orientation thereof.

The first and second reagent probe assemblies 4 and 5 are respectively configured to extract a first and a second reagent and dispense the extracted first and second reagents to corresponding reaction cups 11 on the reaction disk 1. The first and second reagent probe assemblies 4 and 5 are arranged between the reagent disk 2 and the reaction disk 1 in front-to-rear distribution, wherein the first reagent probe assembly 4 is arranged at the rear position and the second reagent probe assembly 5 is arranged at the front position in order to prevent crossed spacial movement therebetween. The sample probe assembly 6 is arranged between the sample disk 3 and the reaction disk 1, configured to extract a sample to be examined from the sample container 13 and dispense it into the corresponding reaction cup 11 on the reaction disk.

The cleaning mechanism 9 is disposed at a rear side of the reaction disk and includes eight-level cleaning nozzles. The first to eighth-level nozzles are arranged over the reaction disk 1 in a clockwise direction, configured to perform eight levels of cleaning in sequence, wherein the first and second-level nozzles are for cleaning using cleaning agents, the third to sixth-level nozzles are for cleaning using de-ion water, and the seventh and eighth-level nozzles are for drying, thereby ensuring cleaned reaction cups to be clean with no residue, such that the testing of biochemical items is able to be continuously processed.

The sample stirrer assembly 8 and the reagent stirrer assembly 7 are arranged around the reaction disk 1, wherein the reagent stirrer assembly 7 is disposed at the right-hand side of the cleaning mechanism 9 and adjacent to the sample probe assembly 6, configured to stir the first reagent or the second reagent dispensed to the reaction cup; and the sample stirrer assembly 8 is disposed at the left-hand side of the cleaning mechanism 9 and adjacent to the first reagent probe assembly 4, configured to stir the sample dispensed to the reaction cup.

The optical detector 10 is configured to detect light absorbency of the reaction cup, and can provide twelve detecting wavelengths, comprising a light source, an optical fiber communication passage, an optical detecting channel, a grating optical splitter, and a photoelectrical detecting element, etc. During the operating process of the biochemical analyzing apparatus, the reaction driving mechanism drives the reaction disk 1 to motivate the reaction cups to pass through the center of the optical detecting channel at a uniform speed, thus completing detection of light absorbency of a given wavelength.

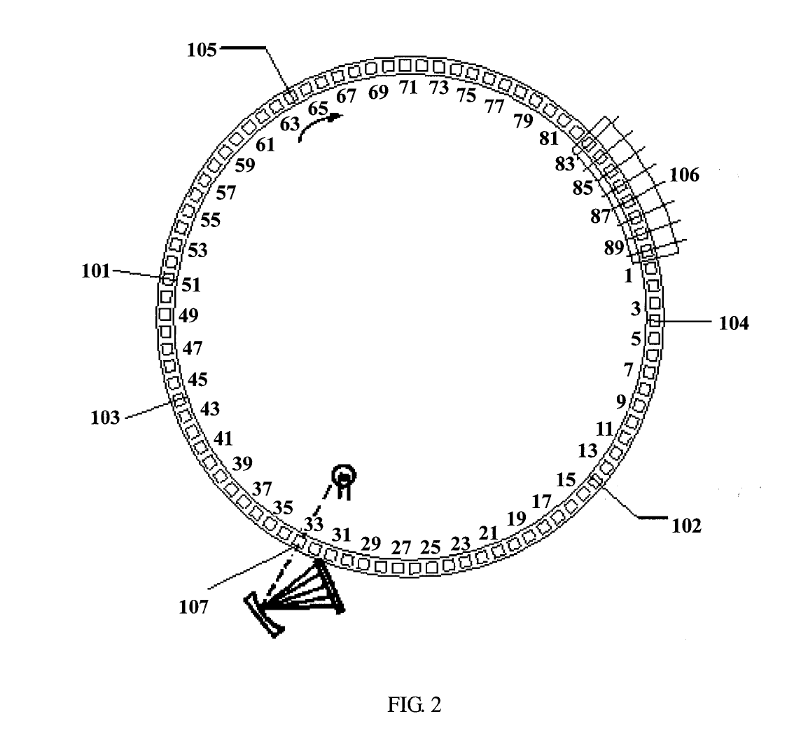

In order to expressly indicate operating positions of each above-described moving component on the reaction disk, a reaction disk position coordinate system is defined. As shown in FIG. 2, a cleaning position of the final-level reaction cup on the reaction disk is defined as a 90# cup position, based on which the serial number of cup positions sequentially increases by one in the clockwise direction, thereby constituting a “reaction disk position coordinate system”. In the reaction disk position coordinate system, the first to eighth-level reaction cups cleaning positions 106 occupy 83# to 90# cup positions in sequence, the 4# cup position works as the reagent stirring position 104, the 14# cup position works as the sample dispensing position 102, the 44# cup position works as the second reagent dispensing position 103, the 51# cup position works as the first reagent dispensing position 101, the 64# cup position works as the sample stirring position 105, and the optical detecting channel 107 corresponds to the 33# cup position in the coordinate system. The reaction disk driving mechanism drives the reaction cups to accomplish the rotary orientation so as to position given reaction cups in sequence at the first dispensing position 101, the sample dispensing position 102, the sample stirring position 105, the second reagent dispensing position 103, the reagent stirring position 104, the optical detecting channel 107 and the reaction cups cleaning positions 106. Accordingly, operations of dispensing the first reagent, the sample and the second reagent to the reaction cups, detecting light absorbency, and cleaning the reaction cups, etc., are accomplished one by one. The first dispensing position 101, the sample stirring position 105, the reaction cups cleaning positions 106, the reagent stirring position 104, the sample dispensing position 102, the optical detecting channel 107 and the second reagent dispensing position 103 are orderly and separately arranged in the direction the same as that of increasing serial number of cup positions on the reaction disk.

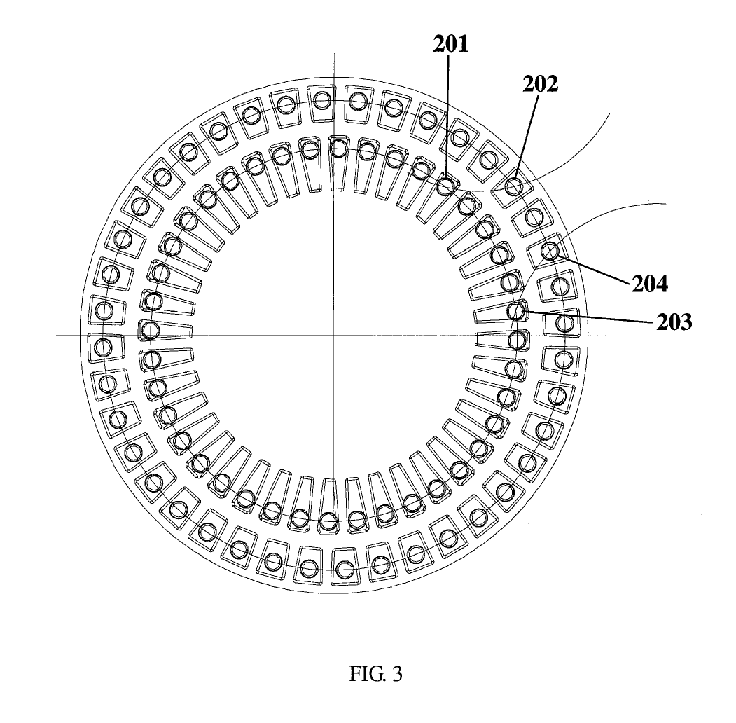

FIG. 3 illustrates operation ubiety between the first reagent probe assembly 4 and the second reagent probe assembly 5 on the reagent disk 2. The reagent position 201 represents the extracting position of the first reagent at the inner circumference of the reagent disk 2. The reagent position 202 represents the extracting position of the first reagent at the outer circumference of the reagent disk 2. The reagent position 203 represents the extracting position of the second reagent at the inner circumference of the reagent disk 2. The reagent position 204 represents the extracting position of the second reagent at the outer circumference of the reagent disk 2.

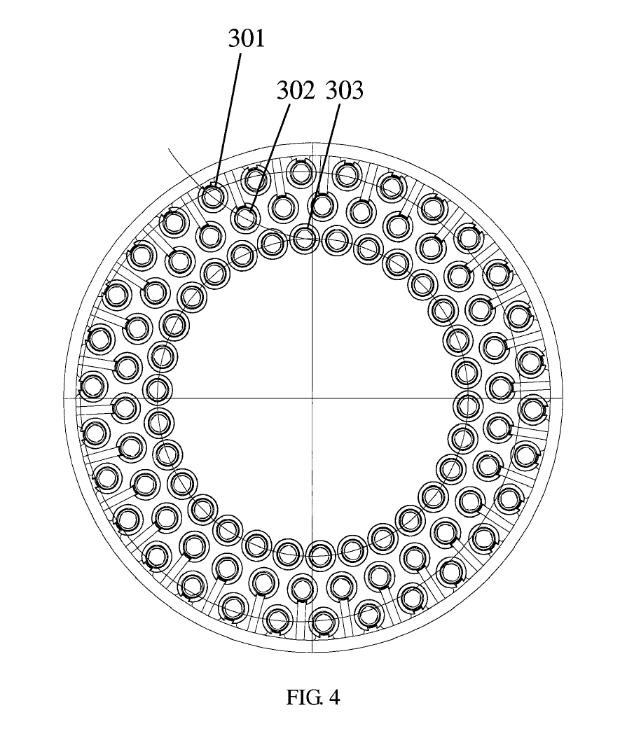

FIG. 4 illustrates operation ubiety of the sample probe assembly 6 on the sample disk 3. The sample position 301 represents the extracting positions of the sample at the outer circumference of the sample disk 3. The sample position 302 represents the extracting positions of the sample at the middle circumference of the sample disk 3. The sample position 303 represents the extracting positions of the sample at the inner circumference of the sample disk 3.

There is also provided a method of operating the entire system corresponding to the biochemical analyzing apparatus described above. An operating cycle is a time interval defined between dispensing the preceding sample and the sequent sample (i.e., a time interval between two sequential sample dispensing operations). Each moving component closely cooperates with each other according to the regulated operation sequence and in sequence performs operations of dispensing the first reagent, the sample and the second reagent, detecting light absorbency, cleaning the reaction cups along the entire loop of the reaction cups on the reaction disk, thereby rapidly accomplishing the testing of a large volume of biochemical items.

Each operating component of the biochemical analyzing apparatus operates according to the operating cycle which is nine seconds. During a unitoperating cycle, every operating component performs the same operating sequence or maintains still.

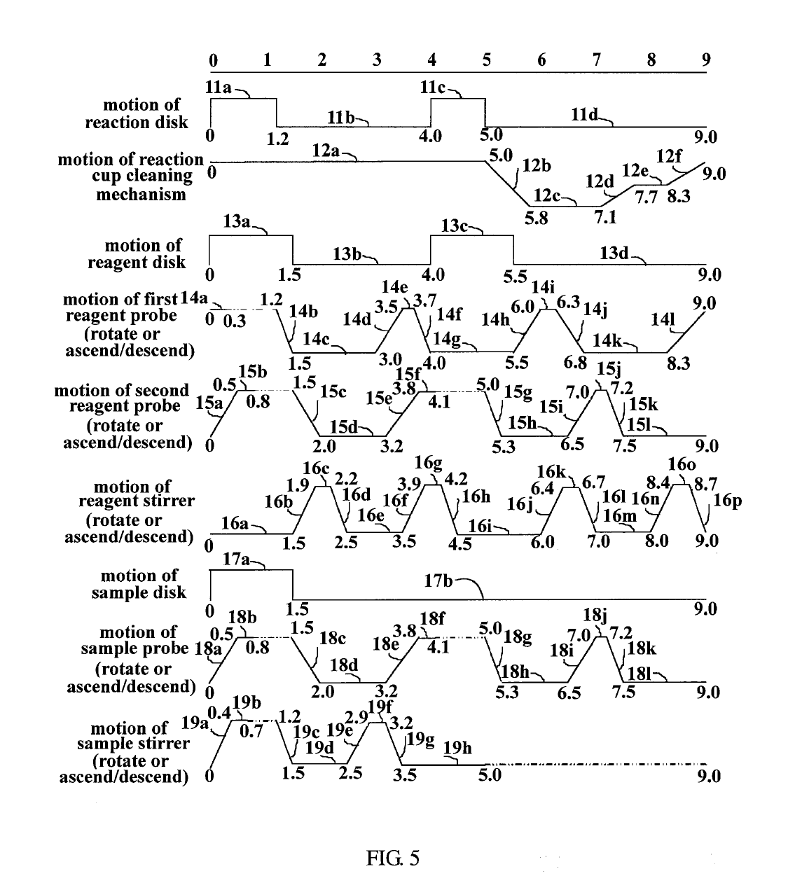

FIG. 5 expressly illustrates the operation sequence of each operating component of the biochemical analyzing apparatus in the operating cycle as well as the logical cooperative relationship among each operating component, wherein the horizontal ordinate represents time, and each tab corresponds to a different operation and follows the respective operation described hereinafter.

During a unit operating cycle, the reaction disk 1 is regulated to perform twice rotations 11a, 11c in the clockwise direction with twice pauses 11b, 11d, and one cup position is added after one round, thereby ensuring the cup position of the reaction disk to increase in the clockwise direction during each operating cycle.

During a unit operating cycle, the cleaning mechanism 9 is firstly held at the position 12a above the reaction disk till the second pause 11d of the reaction disk; the detecting nozzle of the cleaning mechanism 9 descends to the cup bottom 12b of the reaction cup to extract the remaining liquid 12c; and the detecting nozzle ascends to be adjacent to the opening of the reaction cup 12d to infuse the cleaning agent or de-ion water 12e and ascends to the position 12f above the reaction disk before finishing the operating cycle.

During a unit operating cycle, the reagent disk 2 is regulated to perform twice rotations 13a, 13c in the clockwise direction with twice pauses 13b, 13d. The first rotation 13a of the reagent disk 2 positions the second reagent to be extracted by the second reagent probe assembly in the current cycle at the second reagent extracting positions 203, 204, and the second rotation 13c of the reagent disk 2 positions the first reagent to be extracted by the first reagent probe assembly in the current cycle at the first reagent extracting positions 201, 202. Additionally as regulated, the first rotation 13a is not required if the extracting operation of the second reagent is not performed in the current cycle; and the second rotation 13c is not required if the extracting operation of the first reagent is not performed in the current cycle.

The first reagent probe assembly 4 orderly performs operations including dispensing the first reagent, cleaning the inner and outer walls, and extracting the first reagent during a unit operating cycle. At the beginning of the cycle, the first reagent probe assembly 4 rotates to the position 14a above the reaction disk from the upper of the reagent disk. When the reaction disk 1 is at the first pause 11b, the first reagent probe assembly descends to the position 14b in the reaction cup and dispenses in a predetermined volume the first reagent 14c extracted in the preceding cycle (i.e., dispensing the first reagent to the reaction cup at the first reagent dispensing position 101). After dispensing the reagent, the first reagent probe assembly ascends to the position 14d above the reaction disk and rotates to the position 14e above a cleaning cell. The first reagent probe assembly sequentially descends to the position 14f in the cleaning cell to perform cleaning 14g of the inner and outer walls. After cleaning, the first reagent probe assembly ascends to the position 14h above the cleaning cell and rotates to the position 14i to above the reagent disk. When the reagent disk is at the second pause 13d, the first reagent probe assembly descends to the position 14j in the reagent bottle and extracts the first reagent 14k in a predetermined volume. After extracting of the first reagent, the first reagent probe assembly ascends to the position 14l above the reagent disk. As regulated, the operations 14h, 14i, 14j, 14k, 14l are not required if the extracting operation of the first reagent is not performed in the current cycle; the dispensing operation of the first reagent, i.e., the operations 14a, 14b, 14c, 14d, 14eh, 14f, 14g, are not required if the extracting operation of the first reagent is not performed in the preceding cycle; and the first reagent probe would be held in the cleaning cell, if neither the extracting operation nor the dispensing operation of the first reagent is performed in the current cycle.

The second reagent probe assembly 5 orderly performs operations including extracting the second reagent, dispensing the second reagent, and cleaning the inner and outer walls during a unit operating cycle. At the beginning of the cycle, the second reagent probe assembly 5 ascends to the position 15a above the cleaning mechanism and rotates to the position 15b above the reagent disk. When the reagent disk is at the first pause 13b, the second reagent probe assembly descends to the position 15c in the reagent bottle and extracts the second reagent 15d in a predetermined volume. After extracting the first reagent, the second reagent probe assembly ascends to the position 15e above the reagent disk and rotates to the position 15f above the reaction disk. When the reaction disk is at the second pause 11d, the second reagent probe assembly descends to the position 15g in the reaction cup and dispenses the second reagent 15h in a predetermined volume (i.e., dispensing the second reagent to the reaction cup at the second reagent dispensing position 103). After dispensing the second reagent, the second reagent probe assembly ascends to the position 15i above the reaction disk and rotates to the position 15j above the cleaning cell. Then, the second reagent probe assembly descends to the position 15k in the cleaning cell to perform cleaning 15l of the inner and outer walls. As regulated, if the dispensing operation of the second reagent in the current cycle is not performed, the second reagent probe assembly is held in the cleaning cell.

The reagent stirrer assembly 7 orderly performs operations including cleaning the outer wall, stirring the second reagent, cleaning the outer wall and stirring the first reagent during a unit operating cycle. At the beginning of the cycle, the second reagent probe assembly 5 performs cleaning 16a of the outer wall in the cleaning cell. After cleaning, the reagent stirrer assembly ascends to the position 16b above the cleaning cell and rotates to the position 16c above the reaction disk. When the reaction disk is at the first pause 11b, the reagent stirrer assembly descends to the position 16d in the reaction cup and performs stirring 16e of the second reagent (i.e., stirring the second reagent in the reaction cup at the reagent dispensing position 104). After stirring, the reagent stirrer assembly ascends to the position 16f above the reaction disk and rotates to the position 16g above the cleaning cell. Then, the reagent stirrer assembly descends to the position 15h in the cleaning cell to perform cleaning 16i of the outer wall. After cleaning, the reagent stirrer assembly ascends to the position 16j above the cleaning cell and rotates to the position 16k above the reaction disk. When the reaction disk is at the second pause 11d, the reagent stirrer assembly descends to the position 16l in the reaction cup and performs stirring 16m of the first reagent (i.e., stirring the first reagent in the reaction cup at the reagent dispensing position 104). After stirring, the reagent stirrer assembly ascends to the position 16n above the reaction disk and rotates to the position 16o above the cleaning cell, and sequentially descends to the position 16p in the cleaning cell. If the stirring operation of the first reagent in the preceding cycle is not performed, the operation 16a is not required in the current cycle. If the stirring operation of the second reagent is not performed, the operations 16b, 16c, 16d, 16e, 16f, 16g, 16h, 16i are not required in the current cycle. If the stirring operation of the first reagent in the cycle is not performed, the operations 16j, 16k, 16l, 16m, 16n, 16o, 16p are not required in the current cycle.

During a unit operating cycle, the sample disk 3 performs one rotation 17a and one pause 17b to position the samples to be extracted by the sample probe assembly at the sample extracting positions 301, 302, 303.

The sample probe assembly 6 orderly performs operations including extracting samples, dispensing samples, and cleaning the inner and outer walls in a unit operating cycle. At the beginning of the cycle, the sample probe assembly ascends to the position18a above the cleaning cell and rotates to the position 18b above the sample disk. When the sample disk is at the first pause 17b, the sample probe assembly descends to the position 18c in the sample container and extracts the sample 18d in a predetermined volume. After extracting the sample, the sample probe assembly ascends to the position 18e above the sample disk and rotates to the position 18f above the reaction disk. When the reaction disk is at the second pause 11d, the sample probe assembly descends to the position 18g in the reaction cup and dispenses the sample 18h in a predetermined volume (i.e., dispensing the sample to the reaction cup at the sample dispensing position 102). After dispensing samples, the sample probe assembly ascends to the position 18i above the reaction disk and rotates to the position 18j above the cleaning cell. Then, the sample probe assembly descends to the position 18k in the cleaning cell to perform cleaning 18l of the inner and outer walls. If the dispensing operation of samples in the current cycle is not performed, the sample probe assembly is held in the cleaning cell.

The sample stirrer assembly 8 orderly performs operations including stirring the sample and cleaning the outer wall in a unit operating cycle. At the beginning of the cycle, the sample stirrer assembly ascends to the position 19a above the cleaning cell and rotates to the position 19b above the reaction disk. When the reaction disk is at the first pause 11b, the sample stirrer assembly descends to the position 19c in the reaction bottle and performs stirring 19d of the sample (i.e., stirring the sample in the reaction cup at the reagent dispensing position 105). After stirring, the sample stirrer assembly ascends to the position 19e above the reaction disk and rotates to the position 19f above the cleaning cell. Then, the sample stirrer assembly descends to the position 19g in the cleaning cell to perform cleaning 19h of the outer wall. If the stirring operation of sample in the current cycle is not performed, the sample probe assembly is held in the cleaning cell.

During a unit operating cycle, when the reaction disk is at the first pause, the first reagent probe assembly dispenses the reagent to the reaction cup at the first reagent dispensing position, and then the reagent stirrer assembly transfers to the reaction cup at the reagent stirring position and stirs the second reagent dispensed to the reaction cup. If it is a single-reagent item corresponding to the reaction cup, the reagent stirrer assembly does not perform the stirring operation, whereas it is the sample stirrer assembly to transfer to the reaction cup corresponding to the sample stirring position on the reaction disk and stirs the sample dispensed to the corresponding reaction cup.

When the reaction disk is at the second pause, the sample probe assembly dispenses the sample to the reaction cup corresponding to the sample dispensing position on the reaction disk, and the second reagent probe assembly injects the second reagent to the reaction cup corresponding to the second reagent dispensing position on the reaction disk. If it is a single-reagent item corresponding to the reaction cup, the second reagent probe assembly does not perform the injection of the reagent, whereas it is the reagent stirrer assembly to transfer to the reaction cup corresponding to the reagent stirring position on the reaction disk and stirs the first reagent dispensed to the corresponding reaction cup; and the nozzle of the cleaning mechanism descends into the reaction cup corresponding to the cleaning position, performs cleaning of the reaction cup, and ascends above the reaction disk before finishing the operating cycle.

During a unit operating cycle, the reagent disk performs twice rotations with twice pauses. The first rotation of the reagent disk positions the second reagent to be extracted by the second reagent probe assembly at the second reagent extracting position, and in the sequent period of the first pause, the second reagent probe assembly extracts the second reagent from the reagent disk. The second rotation of the reagent disk positions the first reagent to be extracted by the first reagent probe assembly in the current cycle at the first reagent extracting position, and in the sequent period of the second pause, the first reagent probe assembly extracts the first reagent from the reagent disk.

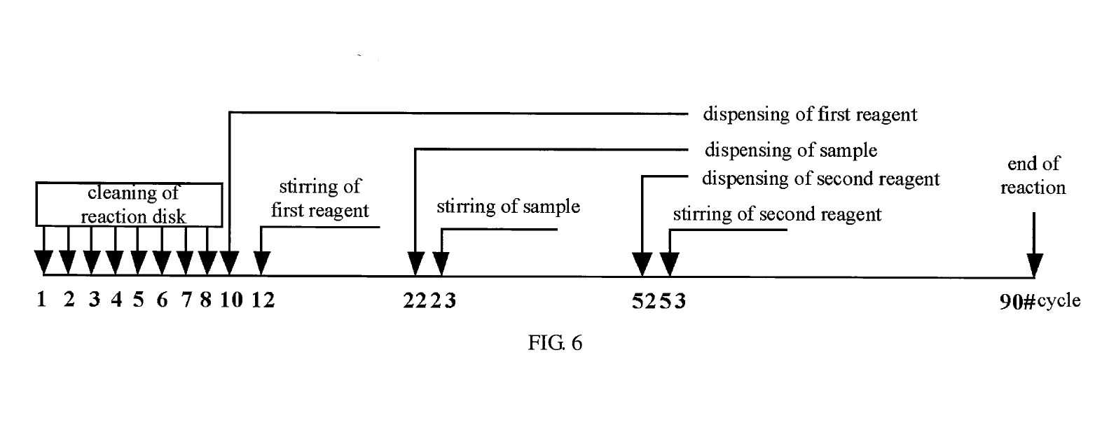

The continuous operates in sequence, according to the above-described operation schedule of each operating component of the biochemical analyzing apparatus, can complete testing for a large volume of single-reagent items as well as two-reagent items and achieve a constant operating speed of 400 tests per hour. FIG. 6 is an operation flowchart of the biochemical analyzing apparatus performing a testing on single/two-reagent items, wherein each specified reaction cup corresponds to a testing item. The specified reaction cup firstly requires eight levels cleaning operation for eight cycles before dispensing the samples. During the 10# cycle, the first reagent probe assembly dispenses the first reagent into the specified reaction cup; during the 22# cycle, the sample probe assembly dispenses the sample into the specified reaction cup; and during the 23# cycle, the sample is stirred. If the item to be tested is a two-reagent item, the second reagent is dispensed after thirty cycles when finishing the dispensing of samples, i.e. the second reagent is dispensed during the 52# cycle, and then the second reagent is stirred during the 53# cycle. It will take about 12 minutes from the dispensation of the first reagent to the end of the testing till the cleaning of the specified reaction cup. In this embodiment, the interval time from the dispensation of the first reagent to the dispensation of the sample is two minutes, thereby ensuring the reaction temperature of the single-reagent measuring item up to, for example, 37° C. The interval time from the dispensation of the sample to the dispensation of the second reagent is four and half minutes, which satisfies the hatch time of the entire two-reagent items and substantially eliminates undesirable reactions therein.

Additionally, apart from that the invention allows one reagent disk to cooperate with two reagent probe assemblies to complete separate dispensing operations of the first and second reagents, it also allows two reagent disks to cooperate with two reagent probe assemblies to complete separate dispensing operation of the two reagents. The reagent disk cooperating with the first reagent probe assembly serves as a first reagent disk, for carrying the first reagent applied in the biochemical testing, and the other reagent disk cooperating with the second reagent probe assembly serves as a second reagent disk, for carrying the second reagent applied in the biochemical testing. During a unit operating cycle, the first and second reagent disks respectively perform one rotation and one pause. The rotation of the first reagent disk positions the first reagent to be extracted by the first reagent probe assembly at the first reagent extracting position, and in the sequent period of the pause of the first reagent disk, the first reagent probe extracts a predetermined volume of the first reagent at the first reagent extracting position. The rotation of the second reagent disk positions the second reagent to be extracted by the second reagent probe assembly at the second reagent extracting position, and in the sequent period of the pause of the second reagent disk, the second reagent probe extracts a predetermined volume of the second reagent at the second reagent extracting position. If the first reagent probe assembly does not perform the extracting operation of the first reagent in the cycle, the first reagent disk is not required to rotate. Likewise, if the second reagent probe assembly does not perform the extracting operation of the second reagent in this cycle, the second reagent disk is not required to rotate either.

The two reagent probe assemblies in this embodiment of the present invention is independent from each other and is respectively used to dispense the first and second reagents, thereby preventing cross contamination between the first and second reagents and greatly improving the operating speed of the apparatus. Each operating component of the biochemical analyzing apparatus orderly performs operations including dispensing the first reagent, the sample and the second reagent to the reaction cups, detecting light absorbency and cleaning the reaction cups, wherein the interval time from the dispensation of the first reagent to the dispensation of the sample is two minutes, thus ensuring the reaction temperature of the single-reagent item up to 37° C. The interval time from dispensation of the sample to dispensation of the second reagent is four and half minutes, which satisfies the hatch time of the entire two-reagent item and substantially eliminates undesirable reactions therein.

The above-mentioned with reference to the preferred embodiments are intended to further describe the present invention in detail, but they should not be construed as limit to the overall scope of the present invention. It will be apparent to those skilled in the art that simple inference and substitution may be made in the apparatus and the method of the present invention without departing from the spirit or scope of the invention, which are within the scope of the appended claims.

What is claimed is:

1. An automatic biochemical analyzing method, in which a row of reaction containers is cyclically arrayed in a loop such that a unit operating cycle is obtained that is defined between dispensing the preceding sample and the sequent sample to the reaction containers, thus the row of reaction containers being transferred so as to motivate at least one reaction container to pass across an optical detecting channel during the unit operating cycle and cause the row of reaction containers to make at least one intermediate pause when no sample is dispensed, wherein a first reagent dispensing position and a sample dispensing position are orderly and separately arranged at the transferring route of the row of reaction containers, so when the row of reaction containers pauses to dispense the sample, the sample is dispensed to a reaction container at the sample dispensing position; and when the row of reaction containers are at the intermediate pause, the first reagent is dispensed to a reaction container at the first reagent dispensing position; as for each reaction container, the operation cycle when the sample is dispensed follows the operation cycle when the first reagent is dispensed.

2. The automatic biochemical analyzing method according to claim 1, wherein the transferring route of the row of reaction containers further has a second reagent dispensing position, the first reagent dispensing position, the sample dispensing position and the second reagent dispensing position being orderly and separately arranged; when the row of reaction containers pauses to dispense the sample, the second reagent is dispensed to a reaction container at the second reagent dispensing position; as for each reaction container, the operation cycle when the second reagent is dispensed follows the operation cycle when the sample is dispensed.

3. The automatic biochemical analyzing method according to claim 2, wherein the transferring route of the row of reaction containers further has a sample stirring position and a reagent stirring position, the first reagent dispensing position, the sample stirring position, the reagent stirring position, the sample dispensing position and the second reagent dispensing position being orderly and separately arranged; when at the intermediate pause, the sample in a reaction container at the sample stirring position is stirred and the second reagent in a reaction container at the reagent stirring position is stirred.

4. The automatic biochemical analyzing method according to claim 2, wherein the dispensing operations of the first reagent, the second reagent and the sample are respectively performed by a first reagent probe assembly, a second reagent probe assembly, and a sample probe assembly; when the row of reaction containers pauses to dispense the sample, the first reagent probe assembly extracts the first reagent in a corresponding reagent container, the second reagent probe assembly dispenses the second reagent to a corresponding reaction container, and the sample probe assembly dispenses the sample to a respective reaction container; and when at the intermediate pause, the first reagent probe assembly dispenses the first reagent in a new corresponding reaction container, the second reagent probe assembly extracts the second reagent in a new corresponding reagent container, and the sample probe assembly extracts the sample from a new respective reaction container.

5. The automatic biochemical analyzing method according to claim 3, wherein the dispensing operations of the first reagent, the second reagent and the sample are respectively performed by a first reagent probe assembly, a second reagent probe assembly, and a sample probe assembly; when the row of reaction containers pauses to dispense the sample, the first reagent probe assembly extracts the first reagent in a corresponding reagent container, the second reagent probe assembly dispenses the second reagent to a corresponding reaction container, and the sample probe assembly dispenses the sample to a respective reaction container; and when at the intermediate pause, the first reagent probe assembly dispenses the first reagent in a new corresponding reaction container, the second reagent probe assembly extracts the second reagent in a new corresponding reagent container, and the sample probe assembly extracts the sample from a new respective reaction container.

6. The automatic biochemical analyzing method according to claim 2, wherein the transferring route of the row of reaction containers further has a cleaning position, the first reagent dispensing position, the cleaning position, the sample dispensing position and the second reagent dispensing position being orderly and separately arranged, and when at the intermediate pause, the reaction container at the cleaning position being cleaned.

7. An automatic biochemical analyzing apparatus, comprising a driving mechanism configured to drive a row of reaction containers to transfer so as to motivate at least one reaction container to pass across an optical detecting channel during a unit operating cycle that is defined between dispensing the preceding sample and the sequent sample to the row of reaction containers arrayed on a reaction disk, and a controlling system configured to cause the row of reaction containers to make at least one intermediate pause when no sample is dispensed during the unit operating cycle, wherein the apparatus further comprises a first reagent probe assembly and a sample probe assembly respectively performing dispensing operations at a first reagent dispensing position and a sample dispensing position, the two dispensing positions being separately arranged at the transferring route of the row of reaction containers, and the controlling system controls the first reagent probe assembly and the sample probe assembly to: dispense the sample to a reaction container at the sample dispensing position via the sample probe assembly when the row of reaction containers pauses to dispense the sample; and dispense the first reagent to a reaction container at the first reagent dispensing position when the row of reaction containers are at the intermediate pause; as for each reaction container, the operation cycle when the sample is dispensed follows the operation cycle when the first reagent is dispensed.

8. The automatic biochemical analyzing apparatus according to claim 7, further comprising a second reagent probe assembly configured to perform dispensing operation at a second reagent dispensing position which is at the transferring route of the row of reaction containers and is interposed between the first reagent dispensing position and the sample dispensing position, wherein when the row of reaction containers pauses to dispense the sample, the controlling system controls the second reagent probe assembly to dispense the second reagent to a reaction container at the second reagent dispensing position; as for each reaction container, the operation cycle when the second reagent is dispensed follows the operation cycle when the sample is dispensed.

9. The automatic biochemical analyzing apparatus according to claim 8, further comprising a sample stirrer assembly and a reagent stirrer assembly, wherein the sample stirrer assembly is configured to perform stirring operation at a sample stirring position at the transferring route of the row of reaction containers, and the reagent stirrer assembly is configured to perform stirring operation at a reagent stirring position at the transferring route of the row of reaction containers; when the row of reaction containers pauses to dispense the sample, the controlling system controls the sample stirrer assembly to stir the sample in a reaction container at the sample stirring position and controls the reagent stirrer assembly to stir the second reagent in a reaction container at the reagent stirring position.

10. The automatic biochemical analyzing apparatus according to claim 9, further comprising a reagent disk configured to support the first and second reagents and a sample disk configured to support the sample, the reagent disk and the sample disk being disposed at two sides of the reaction disk, the first and second reagent probe assemblies being interposed between the reagent disk and the reaction disk, wherein the first reagent probe assembly is arranged at a rear position and the second reagent probe assembly is arranged at a front position, the sample probe assembly being interposed between the reaction disk and the sample disk, the reagent stirrer assembly and the sample stirrer assembly being arranged around the reaction disk, the reagent stirrer assembly being adjacent to the sample probe assembly and the sample stirrer assembly being adjacent to the first reagent probe assembly.

11. The automatic biochemical analyzing apparatus according to claim 9, further comprising a first reagent disk configured to support the first reagent, a second reagent disk configured to support the second reagent, and a sample disk configured to support the sample, the first reagent disk and the second reagent disk being disposed on one side of the reaction disk, the sample disk being disposed on the other side of the reaction disk, the first reagent probe assembly being interposed between the first reagent disk and the reaction disk, the second reagent probe assembly being interposed between the second reagent disk and the reaction disk, in which the first reagent probe assembly is arranged at a rear position and the second reagent probe assembly is arranged at a front position, the sample probe assembly being interposed between the reaction disk and the sample disk, the reagent stirrer assembly and the sample stirrer assembly being arranged around the reaction disk, the reagent stirrer assembly being adjacent to the sample probe assembly, the sample stirrer assembly being adjacent to the first reagent probe assembly.

12. The automatic biochemical analyzing apparatus according to claim 8, further comprising a cleaning mechanism configured to clean the reaction container at a cleaning position at the transferring route of the row of reaction containers, when at the intermediate pause, the reaction container at the cleaning position being cleaned by the cleaning mechanism.
